(19) United States
(12) Patent Application Publication
(10) Pub. No.: US 2008/0138484 A1
(43) Pub. Date: Jun. 12, 2008

(54) Starchy Food Material or Starchy Food

(76) Inventors: Isao Ochi, Tsukuba-gun (JP); Shigeru Ashida, Tsukuba-gu (JP); Jiro Kanamori, Tsukuba-gun (JP); Yukari Nakano, Brussels (BE); Kenji Taguchi, Tsukuba-gun (JP); Atsushi Ohno, Tsukuba-gun (JP); Tsutomu Saito, Izumisano-shi (JP); Eiji Iwaoka, Tsukuba-gun (JP); Junichi Noguchi, Izumisano-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/630,664

(22) PCT Filed: Jul. 12, 2005
(86) PCT No.: PCT/JP2005/012804

§ 371 Date: Dec. 26, 2006

(30) Foreign Application Priority Data
Jul. 13, 2004 (JP) 2004-206617
May 12, 2005 (JP) 2005-139428

(51) Int. Cl. A23L 1/10; A21D 10/00; A23L 1/16

(52) U.S. Cl. 426/555; 426/549; 426/557

(57) ABSTRACT

The texture of a starchy food (for example, biscuits, cookies, cakes, breads, cream puffs, coated and fried foods, snack foods, wheat noodles, Chinese noodles, etc.) is highly improved by using soybean protein in a smaller amount than in the conventional methods. The effect of improving the food texture somewhat varies depending on the water activity of a food. In the case of a food having a high to moderate water content, it is intended to achieve a soft texture, a favorable feeling on the tongue and a high meltability in the mouth. In the case of a food having a low water activity such as baked goods or toast, on the other hand, it is intended to achieve a crispy and light texture. In the case of wheat noodles and Chinese noodles, it is intended to achieve a flexible texture with an adequate elasticity. By using soybean protein in a smaller amount than in the conventional methods, it is intended to sufficiently relieve troubles (loss in the product volume and worsening in appearance) and poor handling properties (lowering in workability) accompanying the use thereof in a large amount. A starchy food material or a starchy food is obtained by adding acid-soluble soybean protein to a starch material such as wheat flour or starch. The acid-soluble soybean protein can be used in an amount of from 0.05 to 7% by weight based on the starchy material.

### TECHNICAL FIELD

The present invention relates to a starchy food material or a starchy food.

### BACKGROUND ART

Foods such as baked confectionery obtained by heating, e.g., baking of dough whose body is principally composed of wheat flour, rice flour or starch, bread obtained by fermentation of dough followed by baking, and noodles such as wheat noodles and Chinese noodles obtained by steaming dough are examples of popular starchy foods in the world. Although addition of a protein material is one of known methods for improving the texture or mouthfeel of such a starchy food, problems pointed out include poor dispersibility of conventional protein materials in dough, which results in insufficient improvement. Then, it is proposed to pulverize the protein material to be used by air stream crushing or freeze crushing so that the average particle diameter becomes especially fine (Patent document 1). The goal of the proposed improvement of the quality of a starchy food is to provide confectionery or bread which has a fluffy texture with favorable feeling on the tongue and high meltability in the mouse in case of steamed foods; or a crispy and solid texture at the outside and soft texture with high meltability in the mouth at the inside in case of baked confectionery; or a soft texture without powdery feeling in case of cakes; or a crispy and brisk texture on the surface with soft and smooth meltablility inside, excellent appearance such as bulkiness and hardly aged during preservation in case of bread, without impairing the texture or mouthfeel of the confectionery or bread.

Further, in a fried food produced by using a starchy food material as a coating (batter) on its surface, a protein material is also added for maintaining a brisk and crispy texture of immediately after frying as long as possible, or for enjoying a brisk and crispy texture as if a food is immediately after cooking even when the food is cooked in a microwave oven after being frozen or cold-stored, (for example, Patent document 2).

Furthermore, use of soybean protein for coatings of spring rolls and chiaotzus is also considered because they are required to have a brisk texture while maintaining a crispy texture even after being left for a long while after being fried or baked (patent document 3).

On the other hand, while firmness of noodles is improved by using soybean protein, flexibility tends to be impaired and the mouthfeel tends to be rather deteriorated.

In addition, while use of soybean protein in starchy foods has been often proposed for improving the quality of the starchy food, such an often proposal suggests not only certain improvement has been obtained by the use of soybean protein, but also further improvement is still demanded.

One of difficulties in starchy foods using soybean protein, particularly bakery products using wheat flour, often encounters is loss in the product volume and evident worsening in appearance. The problems of loss in the product volume and evident worsening in appearance tend to be increased as purity of soybean protein is increased. However, use of soybean protein of lower purity tends to exhibit unpleasant odor of soybean. Then, it is proposed to use soybean protein as an ingredient of wheat flour dough after mixing the soybean protein with an oily-substance without addition of water (Patent document 4). Another problem is that the viscosity of dough increases as increase in the amount of soybean protein used when soybean protein is mixed with wheat flour, thereby deteriorating workability for forming wheat flour dough.

In general, soybean protein has an isoelectric point at about pH 4.5 and is insoluble in an acidic region about the isoelectric point. The function of soybean protein cannot be sufficiently exhibited if it is insoluble. Meanwhile, a method for improving the solubility of soybean protein in an acidic region has been proposed, and soybean protein has been attempted to be used in an acidic region (Patent documents 5 and 6). However, the use of soybean protein under the above-mentioned conditions aims principally to acidic foods, not to non-acidic foods, and the products to be improved as a whole can be hardly concluded to be starchy foods.

Patent document 1: JP 2002-171897 A

Patent document 2: JP 2002-58437 A

Patent document 3: JP 2002-65192 A

Patent document 4: JP 59-118034 A

Patent document 5: JP 53-19669 B

Patent document 6: WO 02/067690 A1

### DISCLOSURE OF THE INVENTION

### Problems to be Solved by the Invention

The present inventors have unexpectedly found that the effect for improving the texture (fluffy texture, favorable feeling on the tongue and high meltability in the mouth in case of baked foods with a high to moderate water content of AW of about 0.5 or more, although the texture somewhat differs depending on a water activity; crispy and light texture in case of baked confectionery and toast having a low water activity; or flexible texture with an adequate elasticity in case of wheat noodles and Chinese noodles) increases by using soybean protein which is soluble in an acidic region at a pH of 4.5 or lower in the production of the above-mentioned starchy food which is not an acidic food as compared with other soybean protein, thereby reducing the amount of soybean protein to be used. Then, problems caused by using a large amount of soybean protein (loss in the product volume and poor appearance) and poor handling properties (lowering in workability) can be alleviated. Thus, the present invention has been completed.

### Means for Solving the Problem

Accordingly, the present invention is:

(1) A starchy food material or a starchy food obtained by blending acid-soluble soybean protein with a starchy material;

(2) The starchy food material or the starchy food according to the above (1), wherein the starchy material principally comprises starchy flour, starch or modified starch thereof, or a mixture thereof;

(3) The starchy food material or the starchy food according to the above (1), wherein the proportion of the acid-soluble soybean protein is in the range from 0.05 to 7% by weight relative to the starchy material;

(4) The starchy food material or the starchy food according to the above (1), wherein the pH of the starchy food material or the starchy food in a hydrated state is in the range from 4.5 to 9;

(5) The starchy food material according to the above (1), wherein the starchy food material is a powder, dough, paste or batter, or aerated products of the latter three; and

(6) The starchy food according to the above (1), wherein the starchy food is biscuits and cookies, cakes, breads, cream puffs, coated fried foods, snack foods, or noodles.

### EFFECT OF THE INVENTION

According to the present invention, the texture of a starchy food can be improved and workability in the production of the starchy food, in particular, workability during the mixing step to the shaping step can also be improved by using a small amount of soybean protein. Further, problems in conventional techniques caused by using a large amount of soybean protein (loss in the product volume and poor appearance) and poor handling properties (lowering in workability) can be sufficiently alleviated.

### BEST MODE FOR CARRYING OUT THE PRESENT INVENTION

The starchy material used in the present invention may be that known in the art. Examples of the material include starchy flour of wheat, rice, corn, potato, tapioca, cassaya and sweet potato; cereal starch obtained from such flour such as wheat starch, corn starch, potato starch, tapioca starch, rice starch, cassaya starch and sweet potato starch; modified starch obtained by chemical or physical treatment such as acetic acid esterification, phosphoric acid cross linking, hydroxypropyl etherification, octenylsuccinic acid esterification and gelatinization; and various dextrin such as dextrin, hardly digestible dextrin and branched dextrin, and a mixture thereof can also be used.

When the starchy material contains gluten as in wheat flour, in particular, when the starchy material contains 30% by weight or more of wheat flour, or when the same amount of gluten as in this case is used together with another starchy material other than wheat flour such as rice flour, problems as encountered by using a large amount of normal soybean protein such as loss in the product volume, poor appearance and poor handling properties due to the increase in viscosity (lowering in workability) can be sufficiently alleviated in cooperation with the viscosity of gluten.

The acid-soluble soybean protein to be used in the present invention has solubility at pH 4.0 of 60% or more, preferably 65% or more, more preferably 80% or more and further preferably 90% or more, and a partial hydrolysate thereof can also be used.

The solubility (%) is a measure of solubilization of the protein in a solvent and can be determined by dispersing a protein powder in water so that the protein content is 5.0% by weight and, after adjusting the pH, if necessary, of the thoroughly stirred solution, centrifuging the solution at 10,000 G for 5 minutes. The proportion of the protein in the supernatant after centrifugation to the amount of the total protein is measured by a protein quantification method such as Kjeldahl method or Lowry method.

While the acid-soluble soybean protein can be produced by various methods, a preferred method is to subject a solution containing soybean protein (soybean milk, defatted soybean milk or an aqueous solution of soybean protein isolate) to a heat treatment at a temperature exceeding 100° C. in an acidic region of a pH lower than the pH at the isoelectric point of the protein. After drying the heated product, a powder of the acid-soluble soybean protein can be obtained, wherein the protein per se is acidic with a pH of 4.5 or lower and has a high solubility in an acidic region.

The acid-soluble soybean protein obtained by the production process disclosed in WO 02/67690 is particularly preferred since it has a high solubility at pH 4.5 or lower. The production process comprises subjecting a solution containing soybean protein to (A) removal or inactivation of polyanionic substances originating from the protein material, for example, decomposition and removal of phytic acid in soybean with phytase, or (B) adding a polycationic substance, for example chitosan, to the solution. The protein solution is subjected to a heat treatment at a temperature exceeding 100° C. in an acidic region having a pH lower than the pH of the isoelectric point of the protein after applying either treatment (A) or treatment (B), or both treatments, and then, usually, followed by drying of the solution.

The acid-soluble soybean protein according to the present invention may be a partial decomposition product of the soybean protein, and it is not excluded that other nitrogen-containing compounds such as hardly soluble protein in an acidic region, hydrolysates of such protein, peptides and amino acids are contained in the starchy food material or starchy food.

While the acid-soluble soybean protein can be used in a wide range from 0.05 to 50% by weight relative to the starchy material, a sufficiently good effect can be also exhibited in a range as small as 3% by weight or less or 2.5% by weight or less as compared with the cases using a larger amount of conventional soybean protein. The upper limit varies depending on a particular purpose, and an amount of 5% by weight or less is preferred in expanded products such as bread and cakes. In the products using the starchy material as small as 10% by weight or less in the product system such as flour paste, acid-soluble soybean protein is preferably added in an amount of 50% by weight or less relative to the starchy material.

While the acid-soluble soybean protein is used in the present invention, the starchy food material or starchy food is not required to be acidic at all. Rather, the protein can be favorably used in the starchy food material or starchy food having a pH in the range from 4.5 to 9 in a hydrated state and, most usually, the pH is in the range from 5 to 7.5. However, a pH in the range from 7.5 to 9 is suitable for Chinese noodles using saline water.

Namely, the starchy foods include biscuits and cookies, cakes, bread, cream puffs, coated fried foods, snack foods, or noodles such as wheat noodles and Chinese noodles. Although these foods cannot be always definitely classified, they also include other baked goods, bakery products such as donuts, hot cakes, corn dogs and steamed products such as steamed bread and bean-jam buns as well as takoyakis (small octopus dumplings) and okonomiyakis (“as-you-like-it” pancakes). The starchy food materials as raw materials of these starchy foods may be powders, dough, pastes, batters or aerated products of the latter three, and collectively include materials named as their mixed features or applications such as premix, mixed powder, vermicelli powder, batter powder, spring roll coating, chiaotzu coating and flour paste.

The starchy food material or the starchy food can be obtained by using known raw materials, additives and aqueous materials in known amounts, and processing them according to known methods. Examples of oils and fats include animal and vegetable oils and fats, fractionated, hydrogenated or interesterified oils and fats thereof, butter, margarine and shortening, and oil-in-water creams thereof. Examples of the emulsifier include lecithin, glycerin fatty acid esters (glycerin fatty acid monoesters, glycerin fatty acid diesters and glycerin fatty acid organic acid esters), polyglycerin fatty acid esters and sucrose fatty acid esters. So-called emulsified oils blended with a desired emulsifier are also commercially available.

Other examples of the additive include thickening agents, stabilizing agents, and dietary fibers such as guar gum, locust bean gum, glucomannan, tamarind seed gum, pullulan, polydextrose, hardly digestible dextrin, guar gum decomposition product, water-soluble soybean polysaccharide, psyllium seed gum, gum Arabic, alginic acid propylene glycol ester and agar. Ammonium hydrogen carbonate, sodium hydrogen carbonate and baking powder containing them may be used as a swelling agent or saline water. Water of the aqueous material can be derived from cow milk, liquors or eggs in addition to water itself.

The method for adding the acid-soluble soybean protein to the starchy material is not limited to directly mixing the protein with the starchy material, and any methods capable of dispersing the acid-soluble soybean protein in the food system can be employed. For example, a dispersion prepared by dispersing the protein in a powder other than the starchy material, in a water-in-oil emulsion or in an oil in advance, or a solution prepared by dissolving the protein in an oil-in-water emulsion can be added to the starchy material.

The starchy material is processed into an end product by heating (baking, steaming, microwave heating or frying) an aqueous dough prepared by blending the acid-soluble soybean protein with the starchy material after fermentation or without fermentation. The dough itself or after heating, the product can be subjected to freezing or cold storage.

### EXAMPLES

Hereinafter, the present invention will be illustrated by Examples. However, the technical scope of the present invention is by no means restricted to these Examples. All the “percents” and “parts” as used herein are percents by weight and parts by weight, respectively, unless otherwise stated.

### Production Example 1

To 5 kg of low denaturation defatted soybean (nitrogen solubilizing index (NSI): 91) obtained by flaking soybeans and extracting and separating oils therefrom with n-hexane as an extraction solvent was added 35 kg of water. The resulting aqueous dispersion was adjusted to pH 7 by adding dilute aqueous sodium hydroxide solution, and soybean protein was extracted by stirring the dispersion at room temperature for 1 hour. Defatted soybean milk was obtained by separating “okara (soybean refuse or soy pulp)” and an insoluble fraction by centrifugation at 4,000 G. The defatted soybean milk was adjusted to pH 4.5 with phosphoric acid, and an insoluble fraction (acid precipitation curd) and a soluble fraction (whey) were obtained by centrifugation at 2000 G using a continuous centrifugal machine (decanter). Then, slurry of an acid precipitation curd was obtained by adding water to the acid precipitation curd so that the solid content became 10% by weight. After adjusting the pH of the slurry at 3.5 with phosphoric acid, the slurry was heated at 120° C. for 15 seconds using a continuous direct heating sterilizer. The sterilized slurry was spray-dried to obtain an acid-soluble soybean protein powder (hereinafter abbreviated as S). The solubility of this protein was 61% at pH 4.0.

### Production Example 2

The slurry of the acid precipitation curd obtained according to the same manner as that in Production Example 1 was adjusted to pH 4.0 with phosphoric acid, and was heated to 40° C. Phytase (manufactured by Novo Co.) corresponding to 8 units per solid content was added to the resulting slurry, and the enzymatic reaction was carried out for 30 minutes. After the reaction, the slurry was adjusted to pH 3.5, and was heated at 120° C. for 15 seconds in a continuous direct heating sterilizer. The sterilized slurry was spray-dried to obtain 1.5 kg of an acid-soluble soybean protein powder (hereinafter abbreviated as T). The solubility of this protein was 95% at pH 4.0.

### Examples 1 to 6

### Production of Sponge Cakes

Whole eggs (150 parts), white sugar (110 parts), an emulsified oil (trade name: PERMING H, manufactured by Fuji Oil Company, Limited, 20 parts), sorbitol preparation (trade name FOODLE 70, manufactured by Towa Chemical Industry Co., Ltd., 10 parts) and water (0 to 5 parts) were mixed with Kenwood mixer (manufactured by Aikoh Co.) and a stirring blade whipper at room temperature (25° C.) at a low speed for 30 seconds. Soft flour (trade name: VIOLET, manufactured by Nippon Flour Mills Co., Ltd., 95 to 99.9 parts), baking powder (trade name: baking powder RED CAN, manufactured by Aikoku Sangyo Co., Ltd., 1 part) and the acid-soluble soybean protein powder T (0.1 to 5 parts) obtained in the above-mentioned Production Example 2 were further mixed with the whipper at a low speed for 30 seconds to obtain a paste of dough. The paste of dough was mixed at a high speed for 3 minutes and 30 seconds using the stirring blade whipper to obtain whipped dough of Examples 1 to 6 with a specific gravity of 0.43 (see Table 1 for variation of parts). Each whipped dough was placed in a baking mold with an inner volume of 1500 cc for producing a size #6 decorated cake, and was baked in an electric oven (trade name: PRINCE II, manufactured by Fujisawa Seisakusho Co.) adjusted to 170° C. for 35 minutes. The results are summarized in Table 2.

### Examples 7 and 8

A paste of dough was obtained according to the blending ratio as shown in Table 1 and the same manner as that described in Example 1 except that 1 to 0.5 parts of the acid-soluble soybean protein powder S obtained in the above-mentioned Production Example 1 was used in place of the acid-soluble soybean protein used in Example 1, and the dough was baked by the same manner as that in Example 1.

### Comparative Examples 1 to 3

A paste of dough was obtained according to the same manner as that in Example 1 except that a commercially available powder of modified soybean milk (trade name: SOYAFIT 2000, manufactured by Fuji Oil Company, Limited, 0 to 10 parts (soybean protein content 62.8% in terms of weight/dry product, solubility of protein; 20% at pH 4.0)) was used in place of the acid-soluble soybean protein used in Examples 1 to 6, and the dough was baked by the same manner as that in Example 1.

TABLE 1

| | Exam- | | Exam- | | | | | | Comparative | Comparative | Comparative |
|---|---|---|---|---|---|---|---|---|---|---|---|
| | ple 1 | Example 2 | ple 3 | Example 4 | Example 5 | Example 6 | Example 7 | Example 8 | Example 1 | Example 2 | Example 3 |
| Whole egg | 150 | 150 | 150 | 150 | 150 | 150 | 150 | 150 | 150 | 150 | 150 |
| (net) | | | | | | | | | | | |
| High grade | 110 | 110 | 110 | 110 | 110 | 110 | 110 | 110 | 110 | 110 | 110 |
| white sugar | | | | | | | | | | | |
| Emulsified oil | 20 | 20 | 20 | 20 | 20 | 20 | 20 | 20 | 20 | 20 | 20 |
| Sorbitol | 10 | 10 | 10 | 10 | 10 | 10 | 10 | 10 | 10 | 10 | 10 |
| preparation | | | | | | | | | | | |
| Water | 5 | 3 | 1 | — | — | — | 1 | — | — | 10 | 5 |
| Soft flour | 95 | 97 | 99 | 99.5 | 99.75 | 99.9 | 99 | 99.5 | 100 | 90 | 95 |
| Acid-soluble | 5 | 3 | 1 | 0.5 | 0.25 | 0.1 | — | — | — | — | — |
| soybean | | | | | | | | | | | |
| protein T | | | | | | | | | | | |
| Acid-soluble | — | — | — | — | — | — | 1 | 0.5 | — | — | — |
| soybean | | | | | | | | | | | |
| protein S | | | | | | | | | | | |
| Powder of | — | — | — | — | — | — | — | — | — | 10 | 5 |
| modified | | | | | | | | | | | |
| soybean milk | | | | | | | | | | | |
| Baking powder | 1 | 1 | 1 | 1 | 1 | 1 | 1 | 1 | 1 | 1 | 1 |
| Total amount | 396 | 394 | 392 | 391 | 391 | 391 | 392 | 391 | 391 | 401 | 396 |
| of dough | | | | | | | | | | | |
| Acid-soluble | 5.26 | 3.09 | 1.01 | 0.50 | 0.25 | 0.10 | 1.01 | 0.50 | — | — | — |
| soybean | | | | | | | | | | | |
| protein (%)/ | | | | | | | | | | | |
| soft flour | | | | | | | | | | | |
| Powder of | — | — | — | — | — | — | — | — | — | 11.1 | 5.26 |
| modified | | | | | | | | | | | |
| soybean milk | | | | | | | | | | | |
| (%)/soft | | | | | | | | | | | |
| flour | | | | | | | | | | | |

TABLE 2

| Quality | | | | | | | | | | | |
|---|---|---|---|---|---|---|---|---|---|---|---|
| evaluation of | Exam- | | Exam- | | | | | | Comparative | Comparative | Comparative |
| baked product | ple 1 | Example 2 | ple 3 | Example 4 | Example 5 | Example 6 | Example 7 | Example 8 | Example 1 | Example 2 | Example 3 |
| Cross- | 56 | 89 | 102 | 103 | 98 | 99 | 102 | 103 | 100 | 81 | 93 |
| sectional area | | | | | | | | | | | |
| index | | | | | | | | | | | |
| Condition of | 2.2 | 3.8 | 4.6 | 4.8 | 3.9 | 3.2 | 4.3 | 4.4 | 2.8 | 3.7 | 3.3 |
| inner layer | | | | | | | | | | | |
| Texture | 3.1 | 4.7 | 4.8 | 4.8 | 4.4 | 3.7 | 4.5 | 4.5 | 3.1 | 4.6 | 3.8 |
| Total score | 5.3 | 8.5 | 9.4 | 9.6 | 8.3 | 6.9 | 8.8 | 8.9 | 5.9 | 8.3 | 7.1 |

The cross-sectional area indices in Table 2 were measured as follows. The baked sponge cake was cut into two equal left and right portions from the upper face to the bottom face using a cake knife, and one of the left or right pieces was used as a measuring sample. The cross section of the sample was copied with an equal magnification using a copy machine (trade name: DOCU-CENTER COLOR A450, manufactured by Fuji Xerox Co., Ltd.), and the portion of the copy paper sheet on which the cross section of the cake was copied was cut for weighing. The cross-sectional area (cm²) of the copied portion was calculated from the area/weight ratio of the copy paper sheet. The cross-sectional area of Comparative Example 1 was fixed to 100 as a reference, and the cross-sectional areas of Comparative Examples 2 and 3 and Examples 1 to 8 were expressed in terms of indices. The larger index showed a better volume.

The conditions of the inner layers of the baked products in Table 2 were evaluated as follows. The conditions of the cross sections of the inner layers of the samples used for the measurement of the cross-sectional area indices were visually evaluated by 10 panelists by scoring with 5 points, and the average values were used for evaluation. A porous inner layer with uniform foaming and hand-made like favorable appearance was evaluated as point 5, an inner layer with ambiguous and non-distinctive features was evaluated as point 3, and an unfavorable inner layer having large to small bubbles together and powdery feeling was evaluated as point 1.

The textures of the baked products in Table 2 were evaluated as follows. The conditions of the cross sections of the inner layers of the samples used for measuring the cross-sectional area indices were tasted by 5 panelists. The samples were evaluated in 10 points and the average values were used for evaluation. A product with good elasticity and crispy feeling in addition to favorable texture with smoothness in the throat was evaluated as point 5, a product that absorbs the saliva and was sticky in the mouth with non-distinctive features was evaluated as point 3, and a product having a powdery and poor texture was evaluated as point 1. The samples in Comparative Examples 2 and 3, in which a powder of modified soybean milk as one of soybean protein products was used in a proportion of 5.26% to 11.1% relative to the soft flour was improved in the condition of the inner layer and texture as compared with the sample of Comparative Example 1 using no soybean protein product. However, the volume of the sponge cakes was liable to be reduced, and a large amount of the powder of modified soybean milk was required for exhibiting the effect of adding soybean protein.

The sponge cakes using the acid-soluble soybean protein of Examples 1 to 8 were excellent in total quality with inner layers having a hand-made like feature and good texture. The effect could be manifested at a lower level of use of soybean protein as compared with the cakes using the powder of the modified soybean milk without decrease of the volume. The effect was distinctive as compared with conventional soybean protein products. The acid-soluble soybean protein powder T gave a more preferable condition of the inner layer and better texture than the powder S.

### Examples 9 to 11

### Production of Butter Cakes

White sugar (120 parts), shortening (trade name: PAMPAS LB, manufactured by Fuji Oil Company, Limited, 5 parts), an emulsified oil (trade name: PERMING H, manufactured by Fuji Oil Co., Ltd., 5 parts) and table salt (2 parts) were mixed with a Kendood mixer (manufactured by Aikoh Co.) and a stirring blade beater at room temperature of 25° C. at a low speed for 30 seconds. Soft flour (trade name: VIOLET, manufactured by Nippon Flour Mills Co., Ltd., 97 to 100 parts), corn starch (5 parts), baking powder (trade name: baking powder RED CAN, manufactured by Aikoku Sangyo Co., Ltd., 3 parts) and the acid-soluble soybean protein powder T (0.5 to 3 parts) were further added and the mixture was mixed with a beater at a low speed for 30 seconds, followed by adding 85 parts of whole eggs (net), 60 to 63 parts of water and 60 parts of salad oil (rapeseed salad oil, manufactured by Fuji Oil Company Limited) in turn. The mixture was mixed with a beater at a low speed for 2 minutes to obtain a homogeneous paste of butter cake dough. The paste of dough (150 g) was placed in a rectangular butter cake baking mold with a size of 130 mm×56 mm×15 mm high, and was baked in an electric oven (trade name: PRINCE II, manufactured by Fujisawa Seisakusho Co.) adjusted to 160° C. for 30 minutes. The results are summarized in Table 4.

### Comparative Example 4

Dough was prepared by the same manner as that in Example 9 except that the acid-soluble soybean protein was not used.

TABLE 3

| | | Example | Example | Comparative |
|---|---|---|---|---|
| | Example 9 | 10 | 11 | Example 4 |
| High grade white | 120 | 120 | 120 | 120 |
| sugar | | | | |
| Shortening | 5 | 5 | 5 | 5 |
| Emulsified oil | 5 | 5 | 5 | 5 |
| Table salt | 2 | 2 | 2 | 2 |
| Soft flour | 97 | 99 | 100 | 100 |
| Corn starch | 5 | 5 | 5 | 5 |
| Baking powder | 3 | 3 | 3 | 3 |
| Acid-soluble soybean | 3.0 | 1.0 | 0.5 | — |
| protein T | | | | |
| Whole eggs (net) | 85 | 85 | 85 | 85 |
| Water | 63 | 61 | 60 | 60 |
| Salad oil | 60 | 60 | 60 | 60 |
| Total amount of dough | 448 | 446 | 445 | 445 |
| Acid-soluble protein | 3.1 | 1.0 | 0.5 | — |
| (%)/soft flour | | | | |

The conditions of the inner layers and textures of the baked products were evaluated by 10 panelists by scoring with 5 points, and the results were summarized in Table 4.

As shown by the results in Table 4, the samples of Examples 9 to 11 to which the acid-soluble soybean protein was added showed greater texture improving effects than the sample of Comparative Example 4.

TABLE 4

| Quality evaluation | | Example | Example | Comparative |
|---|---|---|---|---|
| of baked products | Exam ple 9 | 10 | 11 | Example 4 |
| Condition of inner | 3.9 | 3.5 | 3.3 | 3.1 |
| layer | | | | |
| Texture | 4.7 | 4.3 | 4 | 3.2 |
| Total score | 8.6 | 7.8 | 7.3 | 6.3 |

### Examples 12 to 14

### Production of Donuts

Soft flour (trade name: VIOLET, manufactured by Nippon Flour Mills Co., Ltd., 97 to 99.5 parts), the acid-soluble soybean protein powder T (0.5 to 3 parts), white sugar (33.8 parts), table salt (1.5 parts), baking powder (trade name: baking powder RED CAN, manufactured by Aikoku Sangyo Co., Ltd., 3 parts) and skim milk powder (3 parts) were mixed with a Kenwood Mixer (manufactured by Aikoh Co.) and a stirring blade beater at room temperature of 25° C. at a low speed for 30 seconds. Whole eggs (15 parts, net), water (52 to 55 parts) and plant oil margarine (trade name: PARIOL 500, manufactured by Fuji Oil Company Limited, 60 parts) were melted in a hot water bath and sequentially added, and the mixture was mixed with a beater at a low speed for 2 minutes to obtain a homogeneous paste of donut dough. The compositions of the dough of Examples 12 to 14 are listed in Table 5. The paste of the dough was placed in a donut dough squeezer (trade name: ALUMI DONUT MAKER, manufactured by Kantoshoji Co., Ltd.), and was squeezed into an electric fryer (manufactured by Mach Kiki Co., Ltd.) heated to 180° C. in a proportion of about 45 g per one piece, and the top and back surfaces were fried for 4 minutes in total.

### Comparative Example 5

A paste of dough having the composition in Table 5 was obtained by almost the same blending ratio as in Example 14, except that no acid-soluble soybean protein was used, and the dough was fried under the same conditions as in Example 14.

TABLE 5

| | Experimental | Experimental | Experimental | Comparative |
|---|---|---|---|---|
| | Example 12 | Example 13 | Example 14 | Example 5 |
| Soft flour | 97 | 99 | 99.5 | 100 |
| Acid-soluble | 3 | 1 | 0.5 | — |
| soybean | | | | |
| protein T | | | | |
| High grade | 33.8 | 33.8 | 33.8 | 33.8 |
| white sugar | | | | |
| Table salt | 1.5 | 1.5 | 1.5 | 1.5 |
| Baking powder | 3 | 3 | 3 | 3 |
| Skim milk | 3 | 3 | 3 | 3 |
| powder | | | | |
| Whole eggs | 15 | 15 | 15 | 15 |
| (net) | | | | |
| Water | 55 | 53 | 52 | 52 |
| Margarine | 60 | 60 | 60 | 60 |
| Total amount | 271.3 | 269.3 | 268.3 | 268.3 |
| of dough | | | | |
| Acid-soluble | 3.1 | 1.0 | 0.5 | — |
| soybean protein | | | | |
| (%)/soft flour | | | | |

The conditions of the inner layers and textures of the fried products were evaluated by 10 panelists by scoring with 5 points. The results are summarized in Table 6. As shown by the results in Table 6, the samples of Examples 12 to 14 into which acid-soluble soybean protein was added showed greater improvement in the texture as compared with the sample of Comparative Example 5.

TABLE 6

| Quality | | | | |
|---|---|---|---|---|
| evaluation of | Experimental | Experimental | Experimental | Comparative |
| fried products | Example 12 | Example 13 | Example 14 | Example 5 |
| Condition of | 3.6 | 3.5 | 3.2 | 3.2 |
| inner layer | | | | |
| Texture | 4.6 | 4.6 | 4.2 | 3.3 |
| Total score | 8.2 | 8.1 | 7.4 | 6.5 |

### Example 15

### Production of Cream Puffs

Margarine for cream puffs (trade name: SHOUTOP D, manufactured by Fuji Oil Company Limited, 130 parts) and water (120 parts) were weighed in a Kenwood mixer (manufactured by Aikoh Co.), and the mixture was heated and boiled by gas fire. Soft flour (trade name: VIOLET, manufactured by Nippon Flour Mills Co., Ltd., 79 parts) and strong flour (trade name: EAGLE, manufactured by Nippon Flour Mills Co., Ltd., 20 parts) and the acid-soluble soybean protein powder T (1 part) were added to the boiling mixture of margarine and water. The protein and starch contained in the powder were homogeneously mixed and hydrated with the mixture of margarine and water with a blade beater at a medium speed for 3 minutes. Whole eggs (net, 200 parts), ammonium hydrogen carbonate (manufactured by Happou Shokai Co., swelling agent, 1 part) and sodium hydrogen carbonate (manufactured by Happou Shokai Co., expansion agent, 0.5 part) are pre-mixed, and the mixture is divided into 3 equal portions. One third of the mixture of eggs and the expansion agent were added to the mixture of the powder and the boiling mixture of margarine and water, and the mixture was stirred with the blade beater for 2 minutes at a medium speed. One third of the above-mentioned mixture was further added to the boiling mixture, and the mixture was stirred for 2 minutes at a medium speed. Finally, the remaining one third of the mixture of the swelling agents was added, and the mixture was stirred for 2 minutes at a medium speed to obtain a paste of dough of cream puffs. The results are summarized in Table 7. The paste of dough of cream puffs was placed in a bag, and squeezed onto a steel plate into balls with a weight of 20 g/ball. The balls were baked for 16 minutes in an electric oven (trade name PRINCE II, manufactured by Fujisawa Seisakusho Co.) adjusted to 200° C.

### Comparative Example 6

Dough was prepared by almost the same manner as that in Example 15 except that no acid-soluble soybean protein was used.

TABLE 7

| | Example | Comparative |
|---|---|---|
| | 15 | Example 6 |
| Margarine exclusive for cream puffs | 130 | 130 |
| Water | 120 | 120 |
| Soft flour | 79 | 80 |
| Strong flour | 20 | 20 |
| Acid-soluble soybean protein T | 1 | — |
| Whole eggs (net) | 200 | 200 |
| Ammonium hydrogen carbonate | 1 | 1 |
| (swelling agent) | | |
| Sodium hydrogen carbonate (swelling | 0.5 | 0.5 |
| agent) | | |
| Total amount of dough | 551.5 | 551.5 |
| Acid-soluble soybean protein (%)/ | 1.0 | — |
| soft flour + strong flour | | |

The conditions of the inner layers and textures of the baked product were evaluated by 10 panelists by scoring with 5 points. The results are summarized in Table 8.

As shown in Table 8, the sample of Example 15 in which the acid-soluble soybean protein was added showed a large texture improving effect as compared with the sample of Comparative Example 6.

TABLE 8

| Quality evaluation of | | Comparative |
|---|---|---|
| baked product | Example 15 | Example 6 |
| Condition of inner layer | 3.4 | 3.3 |
| Texture | 4.9 | 2.8 |
| Total score | 8.3 | 6.1 |

### Example 16 and Comparative Example 7

### Production of Cookies

Cookies were produced by a conventional method with the following blending ratios.

TABLE 9

| | Example | Comparative |
|---|---|---|
| | 16 | Example 7 |
| PAMPAS LBH | 30 | 30 |
| NEWCONBOL 500 | 30 | 30 |
| High grade white sugar | 40 | 40 |
| Table salt | 0.3 | 0.3 |
| Vanilla spice | 0.1 | 0.1 |
| Acid-soluble soybean protein T | 1 | — |
| Whole eggs | 10 | 10 |
| Ammonium hydrogen carbonate | 0.5 | 0.5 |
| Water | 3 | 3 |
| Liquor (VSOP) | 2 | 2 |
| Soft flour | 100 | 100 |
| Total amount of dough | 216.9 | 215.9 |
| Acid-soluble soybean protein (%)/ | 1.0 | — |
| soft flour | | |

A vertical table mixer was used for test production of the cookies, and a beater was equipped with as an attachment. The above-mentioned mixture was mixed with stirring at a low speed so that the specific gravity became 0.85, and whole eggs were added therein in 4 to 5 portions. Then, ammonium hydrogen carbonate dissolved in water was added with stirring followed by adding and mixing of the liquor. After stopping to stir, soft flour was added at one time and stirred at the lowest speed until the mixture was coated with the powder. Then, the mixture was roughly mixed with the hand to homogeneity, and the obtained dough was sealed in a vessel and aged overnight in a refrigerator. On the next day, the dough (at a temperature of 6 to 7° C.) was treated with a sheeter at a gauge thickness of 6 mm, and was spread to a thickness of the dough of 6.2 mm. The sheet of the dough was punched (about 11.5 g/sheet) with a circle of 45 mm in diameter, and was baked at the temperatures of the upper oven and lower oven of 200° C. and 160° C., respectively, for 9 minutes. Workability such as preparation of the dough was satisfactory in the Example, and no droop of the dough was observed during baking.

While the cookies of Comparative Example 7 was hardly chewed up and was sensed creaky and stuffy in the mouth, the cookies of Example 16 had an adequate chewing sense with smooth loosening.

### Examples 17 to 19 and Comparative Example 8

### Production of Croquettes

COOK CROQUETTE (trade name, ingredients of croquette manufactured by Nihon Shokken Co., Ltd.) was added to twice by weight of warm water, and thoroughly mixed to homogeneity. After being cooled, the dough of ingredients of croquette was molded to a weight of 45 g/piece using a drum mold (manufactured by Nippon Career Industry Co., Ltd.). Each piece of the molded dough of ingredients was coated with batter (15 g) and crumb (15 g) and, after being frozen rapidly, the dough was fried at 175° C. for 5 minutes. The batter was prepared by dispersing a premix of required powder materials in cold water at 5° C. The blending ratios of the batter are shown in Table 10.

TABLE 10

| | Example | Example | Example | Comparative |
|---|---|---|---|---|
| | 17 | 18 | 19 | Example 8 |
| Soft flour (BLUE | 86 | 84 | 82 | 87 |
| FEATHER) | | | | |
| Acid-soluble soybean | 1 | 3 | 5 | — |
| protein powder T | | | | |
| α-starch | 1.5 | 1.5 | 1.5 | 1.5 |
| (MATSUNORIN | | | | |
| XA) | | | | |
| Xanthan gum | 1 | 1 | 1 | 1 |
| (NEO SOFT XC) | | | | |
| Water | 140 | 140 | 140 | 140 |
| Total | 240 | 240 | 240 | 240 |
| pH of batter solution | 5.64 | 5.03 | 4.70 | 6.04 |
| Viscosity of batter | 1236 | 1332 | 1212 | 1560 |
| solution | | | | |
| Acid-soluble soybean | 1.2 | 3.6 | 6.1 | — |
| protein (%)/soft flour | | | | |

The fried croquettes after being allowed to stand for 7 hours at room temperature were evaluated by a sensory test. The results of evaluation are shown in Table 11. The textures were evaluated by 10 panelists by taking point 5 as a full score, and were evaluated into ranks 5 to 1 from the order of high score, and each sample was evaluated using an average score.

TABLE 11

| | Example | Example | Example | Comparative |
|---|---|---|---|---|
| | 17 | 18 | 19 | Example 8 |
| Brisk texture | 4.3 | 4.2 | 3.9 | 2.7 |
| Crispy texture | 4.2 | 4.4 | 4.6 | 2.9 |
| Meltability in | 3.9 | 3.8 | 3.5 | 3.2 |
| the mouse | | | | |
| Total evaluation | 4.2 | 4.1 | 3.9 | 3.0 |

Brisk and crispy texture was given to the coating of the fried croquettes by adding the acid-soluble soybean protein powder T, and the textures were better than those of the sample in the comparative example. However, hardness at the beginning of chewing was sensed unpleasant when the amount of addition of soybean protein was too large, and the effect for improving the function was liable to be weakened. The balance of textures was good in the range of addition of the soybean protein around 1% in the total evaluation. The croquettes of 4 and 7 hours after cooking were also evaluated. The time-dependent fatigue of coating was small in the examples in which the acid-soluble soybean protein was added, and the textures were better than those in the comparative example.

### Examples 20 and 21, and Comparative Example 9

### Production of Fried Vegetable Mix

TABLE 12

| | Example | Example | Comparative |
|---|---|---|---|
| | 20 | 21 | Example 9 |
| Soft flour (BLUE FEATHER) | 75 | 73 | 76 |
| Raw corn starch | 24 | 24 | 24 |
| Acid-soluble soybean protein T | 1 | 3 | — |
| Whole eggs | 35 | 35 | 35 |
| Baking powder | 0.5 | 0.5 | 0.5 |
| Water | 121 | 123 | 120 |
| Total | 256.5 | 258.5 | 255.5 |
| pH of batter solution | 6.46 | 6.37 | 6.60 |
| Acid-soluble soybean protein | 1.0 | 3.1 | — |
| (%)/soft flour + starch | | | |

TABLE 13

| | Blend ratio |
|---|---|
| Coating liquid (Table 2) | 45.0 |
| Onion (sliced) | 43.0 |
| Carrot (cut pieces) | 15.0 |
| Spinach | 1.5 |
| Soft flour (coating powder) | 6.5 |
| Total | 111.0 |

After adding the coating powder to vegetables with stirring according to the blend ratios in Tables 12 and 13, the coating liquid was added with additional stirring (every pieces were manually prepared). The dough was placed in fry cups for cooking fried vegetable mix, and the mixture was fried at 165° C. for 1 minute and 30 seconds followed by rapid freezing. When cooking, the frozen material was fried again at 170° C. for 1 minute and 15 seconds, and was subjected to the evaluation of texture.

The fried vegetable mix of 2 hours after frying was evaluated by a sensory test. The results of evaluation are shown in Table 14. The textures were evaluated by 10 panelists by taking score 5 as a full score, and were evaluated into ranks 5 to 1 from the order of high score. Each sample was evaluated using an average score.

TABLE 14

| | Example | Example | Comparative |
|---|---|---|---|
| | 20 | 21 | Example 9 |
| Brisk texture | 3.9 | 3.6 | 2.6 |
| Crispy texture | 4.1 | 4.3 | 2.5 |
| Meltability in the | 4.3 | 3.9 | 2.9 |
| mouse | | | |
| Total evaluation | 4.1 | 3.9 | 2.7 |

Brisk and crispy texture was given to the coating by adding the acid-soluble soybean protein with small time-dependent fatigue of the coating, and the results were better than those of the sample in the comparative example. However, since hardness at the beginning of chewing is sensed unpleasant when the amount of addition of soybean protein is too large, a range of addition of around 1% was excellent in the balance of textures in the total evaluation.

### Example 22 and Comparative Example 10

### Production of Bread

The bread was produced by a conventional method according the blend ratio in the table below.

TABLE 15

| | | Comparative |
|---|---|---|
| | Example 22 | Example 10 |
| Strong flour | 100.0 | ← |
| High grade white sugar | 5.0 | ← |
| Table salt | 2.0 | ← |
| Skim milk powder | 2.0 | ← |
| Acid-soluble soybean protein T | 1.0 | — |
| PAMPAS LB | 5.0 | ← |
| Yeast food | 0.1 | ← |
| Yeast | 3.0 | ← |
| Water | 68.0 | 67.0 |
| Total | 186.1 | 184.1 |
| Acid-soluble soybean protein | 1.0 | — |
| (%)/soft flour + starch | | |

PAMPAS LB: shortening (manufactured by Fuji Oil Co., Ltd.)

TABLE 16

| | | One loaf (for |
|---|---|---|
| | | volume |
| | Pullman | measurement) |
| Mixing time | L3M4H1 | ← |
| | ↓L3M4H1 | ← |
| Kneading temperature | 28° C. | ← |
| Floor time | 50 minutes | ← |
| Fermentation room: | 27° C., 75% | ← |
| temperature/ | | |
| humidity | | |
| Weight of division | 220 g | 130 g |
| Bench time | 20 minutes | ← |
| Molding method | U-shape molding | One loaf |
| Drying time | 38 minutes (to | 40 minutes (to 5 mm |
| | 80% of the mold) | over the mold) |
| Drying temperature/ | 38° C., 80% | ← |
| humidity | | |
| Baking temperature | 200° C. | ← |
| (reel) | | |
| Baking time | 40 minuets | 18 minutes |

TABLE 17

| | | Comparative |
|---|---|---|
| | Example 22 | Example 10 |
| Tensile force (BU) | 635 | 601 |
| Elongation (mm) | 134 | 128 |
| Shape coefficient (BU/mm) | 4.74 | 4.70 |

The dough was divided immediately after kneading, and was allowed to stand at 28° C.

The dough was rounded 25 minutes after kneading, and set in a holder after molding.

The dough was measured after further being allowed to stand at 28° C. for 20 minutes.

TABLE 18

| | | Comparative |
|---|---|---|
| | Example 22 | Example 10 |
| Volume (ml) | 553 ± 4 | 570 ± 10 |
| Weight (g) | 112 ± 0 | 112 ± 0 |
| Specific volume (ml/g) | 4.93 ± 0.03 | 5.07 ± 0.09 |

With respect to workability, while the dough of Example 22 in which the acid-soluble soybean protein powder T is blended was a little hard at the initial stage of mixing as compared with the dough of Comparative Example 10 in which no soybean protein was blended, the hardness after kneading was comparable to that of the control with approximately equal workability. The physical properties of the dough were measured with an exo-tensile graph, and the results showed that both dough had approximately equal properties with identical tensile force, elongation and shape coefficient (Table 17). With respect to appearance after baking, the volume was identical, and there were no large differences in the color tone, roughness of the mesh and shape of the inner layer. The specific volume of the bread in the example was almost identical to the volume of the bread in the comparative example (Table 18).

Although the physical properties of the dough and volume of the bread were almost identical between the example and comparative example, the texture of the bread in Example 22 was excellent as compared with the bread in Comparative Example 10. The bread of the example hardly formed aggregation in the mouth as a raw bread before toasting, and showed high meltability in the mouse. After toasting, the bread was favorable by being modified into bread that showed crispy and light texture.

### Example 23

### Production of Non-Fried Noodles

Salts (table salt 30 parts, potassium carbonate 3 parts, sodium carbonate 3 parts) were added to 680 parts of water at room temperature with stirring, and were dissolved by stirring for 10 minutes (preparation of hydration liquid). Wheat flour (trade name: HIRYU, manufactured by Nisshin Flower Milling Co., Ltd., 1800 parts), tapioca starch (trade name: Z-100, manufactured by Nippon Starch Chemical Co., Ltd., 200 parts) and the acid-soluble soybean protein powder T obtained in the above-mentioned Production Example 2 (20 parts) were thoroughly mixed in the powder state, and the mixed powder was sieved through a 200 mesh sieve. The mixed powder was placed in a coat mixer, the hydration liquid was added with stirring at a low speed in five portions in 2 minutes, and the mixture was stirred at a low speed for 7 minutes and medium speed for 8 minutes. Tiny masses of the dough (pH 8.5) were transferred to a noodle making machine, and formed into a sheet of the noodle by complexing (adjusted to a thickness of 2.7 mm). The sheet of the noodle was repeatedly rolled to a final thickness of 0.7 mm. The sheet of the noodle was cut into belts of the noodle with an appropriate length, and was steamed in a steamer for 6 minutes. The steamed noodles were dried at 85° C. for 60 minutes with a hot air dryer, and the dried noodles were cooled by allowing to stand at room temperature.

### Comparative Example 11

The noodles were prepared by the same matter as that in Example 23 except that the acid-soluble soybean protein powder T was not added.

### Comparative Example 12

The noodles were prepared by the same manner as that in Example 23, except that separated soybean protein (trade name: FUJIPRO F (solubility of protein is 10% at pH 4.0), manufactured by Fuji Oil Co., Ltd., 20 parts) was used in place of the acid-soluble soybean protein powder T (20 parts).

TABLE 19

| | | Comparative | Comparative |
|---|---|---|---|
| | Example 23 | Example 11 | Example 12 |
| Water | 680 | 680 | 680 |
| Salts | 36 | 36 | 36 |
| Wheat flour | 1800 | 1800 | 1800 |
| Tapioca starch | 200 | 200 | 200 |
| Acid-soluble soybean | 20 | — | — |
| protein T | | | |
| Separated soybean | — | — | 20 |
| protein | | | |
| Total | 2736 | 2716 | 2736 |

TABLE 20

| | | Comparative | Comparative |
|---|---|---|---|
| | Example 23 | Example 11 | Example 12 |
| Workability | Flexible | Standard | Hard and |
| | | | fragile |
| Texture | Elastic and | Powdery and | Hard and |
| | flexible | sticky | brittle |
| Softening with | 5 minutes | 7 minutes | 7 minutes |
| hot water | | | |
| Extension with | None | Yes | Yes |
| hot water | | | |
| Loosening | Readily | Hardly | Hardly |
| | loosened | loosened | loosened |

As shown in Table 20, while the belts of the noodle of Comparative Example 12 were sensed to be harder and more fragile during processing than the belts of the noodle in Comparative Example 11, the belts of the noodle of Example 23 were sensed to be softer and more flexible than the belts of the noodle in Comparative Example 11. While separated soybean protein apparently causes an increase of the viscosity of the dough, the viscosity of the dough was properly decreased instead of being increased by using the acid-soluble soybean protein.

The noodles were placed in a cup and hot water was poured into the cup before evaluation of the noodles. Ten panelists evaluated the texture of the noodles after softening with hot water by a sensory test. When observing the texture of the noodles after softening with hot water, the noodles of Comparative Example 11 were sensed powdery, readily collapsed and sticky, and the noodles of Comparative Example 12 were hard and liable to be cut into small pieces. In contrast, the noodles of Example 23 were favorable by being less powdery and sticky with adequate elasticity and flexibility when chewing.

Since instant dry foods involve peculiar problems of softening, extension and loosening with hot-water, these problems were evaluated.

Softening with hot water: When restoration of the noodles were observed at 3, 5 and 7 minutes after softening with hot water, hard cores were left behind at 5 minutes after softening and the noodles were completely restored after 7 minutes in Comparative Examples 11 and 12. However, the noodles of Example 23 were almost completely restored after 5 minutes and showed a tendency that rapidly softens with hot water.

Extension with hot water: The texture of the noodles was investigated at 10 minutes after softening with hot water. While the noodles of Comparative Examples 11 and 12 became softer and stickier with apparent feature of extension with hot water, the noodles of Example 23 became soft with adequate hardness and showed a tendency that hardly causes extension with hot water.

Loosening: When loosening of the noodles was observed at 3 and 5 minutes after softening with hot water, while the noodles of Comparative Examples 11 and 12 remained entangled with less loosening, the noodles in Example 23 apparently showed a tendency of readily loosened with fewer tangling.

The above-mentioned results showed that the acid-soluble soybean protein of the present invention affords effects against softening, extension and loosening with hot water as the problems of the instant dry foods.

While an effect for improving the quality of the noodles similar to that of Example 23 was obtained when the acid-soluble soybean protein powder S obtained in the above-mentioned Production Example 1 was used in place of the acid-soluble soybean protein powder T in Example 23, the noodles in Example 23 were more excellent in flexibility of the texture. Accordingly, it was evident that addition of the acid-soluble soybean protein affords an effect for improving the quality of the non-fried noodles.

### Examples 24 to 26

### Production of Wheat Noodles

Table salt (4 parts) was added to water (40 parts) at room temperature with stirring, and was dissolved by stirring for additional 10 minutes (preparation of hydration liquid). The acid-soluble soybean protein powder T (0.5, 1.0 or 1.5 parts) was thoroughly mixed with medium flour for wheat noodles (manufactured by Nitto Flour Milling Co., Ltd., 100 parts) in a powder state, and the mixed powder was sieved through a 200 mesh sieve. The mixed powder was placed in a coat mixer, the hydration liquid was added with stirring at a low speed in 5 portions in 2 minutes, and the powder was scraped 5 minutes after the start of stirring followed by stirring for additional 5 minutes (10 minutes in total). Tiny masses of the dough were transferred to a noodle making machine, and a sheet of the noodle was produced by complexing (5.0 mm in thickness). The sheet of the noodle was repeatedly rolled three times to a final thickness of 2.0 mm, and was cut into belts with a width of 3 mm using a noodle cutting machine to obtain raw wheat noodles.

After allowing the raw noodles to stand in a refrigerator overnight, they were boiled in boiling water with a volume of 10 times of the volume of the raw noodles for 10 minutes in order to obtain the noodles (edible noodles).

### Comparative Example 13

The noodles were prepared by the same manner as that in Example 24 except that the acid-soluble soybean protein powder was not added.

TABLE 21

| | Example | Example | Example | Comparative |
|---|---|---|---|---|
| | 24 | 25 | 26 | Example 13 |
| Water | 40 | 40 | 40 | 40 |
| Table salt | 4 | 4 | 4 | 4 |
| Wheat flour | 100 | 100 | 100 | 100 |
| Acid-soluble | 0.5 | 1.0 | 1.5 | — |
| soybean protein T | | | | |

TABLE 22

| | Example | Example | Example | Comparative |
|---|---|---|---|---|
| | 24 | 25 | 26 | Example 13 |
| Hardness, firmness | Elastic and firm | | | Weak |
| (order of score) | (3) | (1) | (2) | (4) |

| | | |
|---|---|---|
| Extension 5 | Preferable condition | Rather |
| minutes after | immediately after boiling | extended, |
| boiling | | soft |
| Extension 10 | A little extended but | More |
| minutes after | stiff | softened |
| boiling | | |

Texture immediately after boiling and extension by boiling when the noodles were immersed in warm soup were evaluated by 10 panelists by a sensory test. With respect to the texture immediately after boiling, the noodles in Comparative Example 13 were unfavorable in hardness with fewer elasticity and firmness. However, the noodles in Examples 24 to 26 were confirmed to have good texture with sufficient hardness, elasticity and firmness. An amount of addition of 1.0 part of the acid-soluble soybean protein is most favorable in the hardness, elasticity and firmness of the noodles, followed by the amounts of addition of 1.5 parts and 0.5 parts.

Extension by boiling was evaluated 5 minutes and 10 minutes after immersing the noodles immediately after boiling in a soup adjusted at 80° C. While the noodles of the comparative example were soft and a little extended at 5 minutes after immersion, the noodles of the examples maintained a texture corresponding to the texture immediately after boiling. While the noodles in the comparative example 10 minutes after immersion were more extended with soft and less firm texture and hardness, it was confirmed that hardness, elasticity and firmness were maintained in the noodles of the examples irrespective of a little extension by boiling.

The above-mentioned results indicate that adding the acid-soluble soybean protein affords an effect for improving the quality of wheat noodles.

### Example 27

### Flour Paste

A flour paste was prepared using the acid-soluble soybean protein powder T obtained in the above-mentioned Production Example 2. Frozen egg yolk (trade name: GOLD YOLK, manufactured by Q.P. Corporation, 4.0 parts), lactoglobulin (trade name: SUNLACT N5, manufactured by Taiyo Kagaku Co., Ltd., 2.0 parts), skim milk powder (4.0 parts), dextrin (10.0 parts), water (44.5 parts), rapeseed oil (manufactured by Fuji Oil Company Limited, 14.0 parts), granulated sugar (16.0 parts), the acid-soluble soybean protein powder T (1.0 part) and corn starch (trade name: CORN STARCH MXPP, manufactured by Nippon Starch Chemical Co., Ltd., 4.5 parts) were added and blended for 10 minutes at 60° C. The mixed solution showed a pH of 5.9. After homogenizing under a pressure of 100 kg/cm², starch was converted into a paste of α-starch by indirect heading of a kneader to 100° C. Formability of the paste was firm immediately after taking out of the kneader. The flour paste after cooling in a refrigerator (5° C.) showed good flavor with smooth texture and high meltability in the mouse.

### Comparative Example 14

A flour paste was prepared by the same manner as that in Example 27 except that no acid-soluble soybean protein was added. The paste was firm with formability immediately after taking out of the kneader. While the flavor of the flower paste was good after cooling in a refrigerator (5° C.), the texture showed strong pasty sense of starch, and meltability in the mouse was not so preferable with quite heavy sense.

### Example 28

### Acidic Flour Paste

An acidic flour paste was prepared using the acid-soluble soybean protein powder T obtained in the above-mentioned Production Example 2. Commercially available orange juice (100%, 20 parts), water (35.5 parts), rapeseed oil (manufactured by Fuji Oil Co., Ltd., 14 parts), granulated sugar (23 parts), the acid-soluble soybean protein powder T (3 parts) and corn starch (trade name: MXPP, manufactured by Nippon Starch Chemical Co., Ltd., 4.5 parts) were added, and were blended thereafter at 60° C. for 10 minutes. The blended liquid showed a pH of 3.8. After homogenizing under a pressure of 100 kg/cm², starch was converted into a paste of α-starch by heating to 85° C. by indirect heating of the kneader. The paste was firm and showed good formability immediately after taking out of the kneader. The texture of the flour paste after cooling in a refrigerator (5° C.) was also firm with good meltability in the mouth. The flavor of orange was clearly sensed, and the paste was finished with natural taste.

### Example 29

A flour paste was obtained according to the same manner in Example 28 except that the acid-soluble soybean protein powder T (2 parts) and water (36.5 parts) were used in place of 3 parts and 35.5 parts, respectively, in Example 28. While formability of the paste was a little inferior to that of the flour paste in Example 28, the texture was firm. Meltability in the mouth was excellent, and the flavor was sensed to be natural juice flavor as in Example 28.

### Comparative Example 15

The total amount of the acid-soluble soybean protein in Example 28 was substituted with milk whey protein (trade name: SUNLACT N5, manufactured by Taiyo Kagaku Co., Ltd.). The pH of the mixed solution was adjusted to 3.8 with lactic acid. The flour paste was prepared by the same manner as that in Example 28 except that the above-mentioned procedure was used. Unlike in Example 28, the flour paste thus obtained showed no formability and was flowed by tilting the vessel, and was a liquid that was dripped when the paste was tried to be squeezed with a die. Orange flavor was obscure by being mixed with milk flavor, and no clear flavor of orange was sensed. The taste was not as favorable as that of Example 28 because of a strong sour taste.

### Comparative Example 16

A flour paste was prepared according to the same manner as that in Example 28 except that the amounts of use of corn starch and granulated sugar in Comparative Example 15 were changed to 7.5 parts and 20 parts, respectively, and the pH of the mixed solution was adjusted to 3.8 with lactic acid. While the paste obtained showed better formability than in Comparative Example 15, the formability was derived from starch. The texture was inferior to that in Example 29 with poor feeling through the throat and pasty sense of starch.

The blend ratios and evaluations of flour pastes in Examples 28 and 29, and Comparative Examples 15 and 16 are summarized in Table 23.

TABLE 23

| | Example | Example | Comparative | Comparative |
|---|---|---|---|---|
| | 28 | 29 | Example 15 | Example 16 |
| Orange | 20 | 20 | 20 | 20 |
| juice | | | | |
| Water | 35.5 | 36.5 | 35.5 | 35.5 |
| Rapeseed | 14 | 14 | 14 | 14 |
| oil | | | | |
| Granulated | 23 | 23 | 23 | 23 |
| sugar | | | | |
| Acid- | 3 | 2 | — | — |
| soluble | | | | |
| soybean | | | | |
| protein T | | | | |
| Milk whey | — | — | 3 | — |
| protein | | | | |
| Corn starch | 4.5 | 4.5 | 4.5 | 7.5 |
| Total | 100 | 100 | 100 | 97 |
| Evaluation | Good | Good but | Flavor is | Substantial |
| | | formability | hardly | formability, |
| | | is inferior | sensed, | but powdery and |
| | | a little | poor | unpleasant |
| | | | formability | thorough the |
| | | | | throat |

### Example 30

An acidic flour paste was prepared by using the acid-soluble soybean protein obtained in the above-mentioned Production Example 2. A condensed and turbid juice of passion fruits (manufactured by Tokyo Food Techno Co., Ltd., sugar content 50.5°, acidity 13.90%, 10 parts), water (45.5 parts), rapeseed oil (manufactured by Fuji Oil Company Limited, 14 parts), granulated sugar (23 parts), the acid-soluble soybean protein powder T (3 parts) and corn starch (trade name: MXPP, manufactured by Nippon Starch Chemical Co., Ltd., 4.5 parts) were added, and were blended at 60° C. for 10 minutes. The pH of the mixed solution was 3.5. After homogenizing under a pressure of 100 kg/cm², starch was converted into a paste of α-starch by heating to 85° C. by indirect heating of the kneader. Formability of the paste was firm immediately after taking out of the kneader. The paste was firm and showed good meltability in the mouth after cooling in a refrigerator (5° C.). The flavor of passion fruits was clearly sensed, and the paste was finished with natural taste.

### Example 31

### Production of Acidic Cream by Blending Acid-Soluble Soybean Protein

The acid-soluble soybean protein T (2 parts) and sucrose fatty acid ester (trade name: RYOTO SUGAR ESTER S-570, manufactured by Mitsubishi Kagaku Foods Corporation, 0.2 parts) were mixed in a powder state, and an aqueous phase was prepared by dissolving the mixture by adding water (52.8 parts). Salad oil (45 parts) was added to the solution, and the oil phase and aqueous phase were pre-emulsified by stirring with a homomixer at 70° C. for 15 minutes, followed by homogenizing under a homogenizing pressure of 1 MPa. The homogenized mixture was sterilized with an ultra-high temperature sterilizer at 144° C. for 4 seconds by direct heating and homogenized under a homogenizing pressure of 4 MPa, and the mixture was immediately cooled to S° C. An acidic cream (pH 3.5) was obtained by aging the mixture for about 24 hours after cooling.

A sponge cake was produced by adding 25 parts of the above-mentioned acidic cream blended with the acid-soluble soybean protein relative to 100 parts of the blend in Comparative Example 1. The sponge cake obtained had a hand-made like inner layer characteristic and showed good texture as in Examples 1 to 8. Since the same effect is obtained by adding the acid-soluble soybean protein after processing into an oil-in-water cream in advance, it is possible to blend the acid-soluble soybean protein to use as a cream for kneading into the sponge cake.

### Example 32

### Production of Shortening Blended with Acid-Soluble Soybean Protein

The acid-soluble soybean protein T (16.7 parts) was added to a shortening (trade name: PAMPAS LB, manufactured by Fuji Oil Co., Ltd., 83.3 parts) that had been dissolved by heating, and a shortening blended with the acid-soluble soybean protein was prepared by kneading with stirring. Bread was produced by the same method as in Example 22, except that the above-mentioned shortening (6 parts) blended with the acid-soluble soybean protein was used in place of the acid-soluble soybean protein (1 part) and PAMPAS LB (5 parts) in Example 22.

As a result, the bread was almost identical to the bread produced in Example 22 with respect to workability, physical properties of the dough, appearance and specific volume after baking as well as texture. The acid-soluble soybean protein of the present invention was shown to be able to be used as a shortening by preliminarily kneading into shortening.

1. A starchy food material or a starchy food obtained by blending acid-soluble soybean protein with a starchy material.

2. The starchy food material or the starchy food according to claim 1, wherein the starchy material principally comprises starchy flour, starch or modified starch thereof, or a mixture thereof.

3. The starchy food material or the starchy food according to claim 1, wherein the proportion of the acid-soluble soybean protein is in the range from 0.05 to 7% by weight relative to the starchy material.

4. The starchy food material or the starchy food according to claim 1, wherein the pH of the starchy food material or the starchy food in a hydrated state is in the range from 4.5 to 9.

5. The starchy food material according to claim 1, wherein the starchy food material is a powder, dough, paste or batter, or aerated products of the latter three.

6. The starchy food according to claim 1, wherein the starchy food is biscuits and cookies, cakes, breads, cream puffs, coated fried foods, snack foods, or noodles.
